(19) United States
(12) Patent Application Publication
(10) Pub. No.: US 2018/0009982 A1
(43) Pub. Date: Jan. 11, 2018

(54) COMPOUNDED COPOLYAMIDE POWDERS

(71) Applicant: A. SCHULMAN GmbH, Kerpen (DE)

(72) Inventors: Jonathan Martin STEELE, Kettering (GB); Said IBNO SALAH, Aachen (DE); Laurent HERSCHKE, Hattersheim (DE); Dirk HAENSCH, Hauset (BE); Remi Didier Robert GARDAN, Montereau-Fault-Yonne (FR)

(21) Appl. No.: 15/206,845

(22) Filed: Jul. 11, 2016

(51) Int. Cl. C08L 77/06; C08J 3/20; C08J 3/12; C08K 5/00

(52) U.S. Cl. CPC C08L 77/06; C08K 5/005; C08J 3/20; C08K 5/0041; C08J 3/12; C08J 2377/06; C08L 2201/08; C08L 2205/02; C08L 2205/06

(57) ABSTRACT

Compounded copolyamide powders, processes for preparation of compounded copolyamide powders, articles made therefrom and uses.

The present invention is directed to compounded copolyamide powders, processes for their preparation and their uses, in particular in selective laser sintering, high speed sintering (HSS), powder bed fusion, multi jet fusion, 3-D printing and/or Additive Manufacturing.

Any of the documents mentioned in the present application are incorporated by reference in their entirety as long as they do not contradict the matter of the present invention.

### PRIOR ART

Laser sintering is a 3D (three dimensional) printing technique which produces high quality functional parts. This technique has been practiced for over two decades, however, only a handful of polymers have a desirable processing window for this technique and provide rapidly manufactured parts with adequate mechanical performance for the envisioned applications.

Polyamide copolymers as well as aromatic polyamide copolymers are known in the art like for instance WO 96/06881 A2. U.S. Pat. No. 8,591,797 describes a copolyamide powder and its preparation. U.S. Pat. No. 9,000,082 B2 describes Cu₂O-based heat and light stabilized polyamide-compositions for molding. US 2004/0102539 A1 describes powders with improved recycling properties, process for its production, and use of the powder in a process for producing three-dimensional objects, wherein carboxylic acids are added to the polymer as regulators. EP 1 443 073 A1 describes polyamide powder compositions for the coating of moldings comprising certain flow aids. WO 2005/082973 A1 describes copolymers that are being selected based on their MFR values. WO 2009/138692 A1 describes a method for increasing the difference between the melting temperature and the crystallization temperature of a polyamide powder by copolymerizing minor amounts of monomers. WO 2012/076528 A1 discloses a process for manufacturing articles by selective fusion of polymer powder based on a copolyamide of type 6 having a low enthalpy of cold crystallization.

In the non-prepublished U.S. provisional application 62/101,450, filed Jan. 9, 2015 improved PA6.12 copolymers are described.

In the industry high heat/aromatic polymers (e.g. aromatic PA6.12, PPS, LCP) that can fill the performance gap between PA12 and PEEK to produce small series, intricate or custom parts through additive manufacturing/selective laser sintering process are desired. It is desirable to supply high heat polyamide polymer powders for laser sintering processes with higher continuous use temperature, higher stiffness (higher tensile strength at break) than the conventional glass beads filled PA12 and PA11 powders while avoiding the drawbacks of PA6 powders (higher temperature SLS machine required, high residual humidity requiring powder drying before use, high level of part reject due to warpage and curling) and with wider processing window (>45° C.) and higher crystallization rate than other co-polyamides (PA6.10, PA12.12, PA10.12) and that can be used on existing installed laser sintering machines. In addition it is desirable to produce such powder with shorter production cycle i.e. faster heating and cooling cycle, high resolution during part building process (<100 micron), good part dimensional stability (<1% shrinkage) and high re-use rate (>5×, >30% ideally 50% re-use level) to produce minute/very small and large parts of intricate geometry at high throughput to address the challenge of the 3D printing industry while moving from Rapid Prototyping to Rapid Manufacturing. In addition it is desirable to produce a versatile high heat polyamide polymer powder for use in laser sintering and high speed sintering processes e.g. a powder with high thermal stability and color stability upon high temperature use (>70 h at processing temperature>180° C.). In addition it is desirable to produce black high heat polyamide polymer powders for use in laser sintering to produce semi-structural parts for use in industrial and transportation applications such as automotive and aerospace applications. It further is desired to provide single use powder having excellent further properties, substantially better dimensional accuracy and tensile strength at yield) for applications where high security factors are common practice, such as sport racing cars or aerospace components.

### Object of the Invention

It was accordingly an object of the present invention to provide high heat polyamide polymer powders for laser sintering processes with higher continuous use temperature, particularly above 100° C., more particularly above 115° C., higher stiffness (higher tensile strength at break) than the conventional, or glass bead filled PA12 and PA11 powders while avoiding the drawbacks of PA6 powders (high residual humidity requiring powder drying before use, high level of part reject due to warpage and curling) and with wider processing window (>45° C.) and higher crystallization rate than other co-polyamides (PA6.10, PA12.12, PA10.12) and that can be used on existing installed laser sintering machines.

It was an additional object of the present invention to provide a process for preparation of such powder with shorter production cycle i.e. faster heating and cooling cycle, high resolution during part building process (<100 micron), good part dimensional stability (<1% shrinkage) and high re-use rate (>5×, >30% ideally 50% re-use level) to produce minute and large parts of intricate geometry at high throughput to address the challenge of the 3D printing industry while moving from Rapid Prototyping to Rapid Manufacturing.

It was an additional object of the present invention to provide a versatile high heat polyamide polymer powder for use in laser sintering, high speed sintering processes and/or Additive Manufacturing processes e.g. a powder with high thermal stability and color stability upon high temperature use (>70 h at processing temperature>180° C.) to produce decorative and semi-structural parts, and in particular for use in automotive and aerospace applications.

It was an additional object of the present invention to provide single use laser sintering/3-D printing/Additive Manufacturing powders having excellent further properties.

### Solution of the Invention

These and other objects that are apparent to the person skilled in the art when reading the present specification have been solved by the matter outlined in the description and in particular the claims.

### Definitions

Unless otherwise defined, all technical and scientific terms used herein have the same meaning as commonly understood by a person skilled in the art to which this invention pertains.

As used in the specification and the appended claims, the singular forms “a,” “an,” and “the” are intended to include the plural forms as well, unless the context clearly indicates otherwise.

Unless otherwise indicated, all numbers expressing quantities of ingredients, reaction conditions, and so forth used in the specification and claims are to be understood as being modified in all instances by the term “about.”

Every numerical range given throughout this specification will include every narrower numerical range that falls within such broader numerical range, as if such narrower numerical ranges were all expressly written herein.

In the context of the present invention the term “and/or” includes any single elements as well as all possible combinations of the elements cited in the respective list.

Unless otherwise indicated, all numbers expressing quantities are to be understood as being amounts in weight.

Unless otherwise indicated, all reaction and/or process steps are to be understood as being conducted at normal atmospheric pressure, that is at 1013 mbar.

Unless otherwise indicated, all temperatures given are in degrees Celsius (° C.).

Unless otherwise indicated the term “nylon” in the context of the present invention is used as a generic term for aliphatic or semi-aromatic polyamides.

In the present invention, the nylon-nomenclature which employs numbers to describe the number of carbons between acid and amine functions is usually used for the copolyamides. That means that for example the term PA6.12 is directed to a copolyamide mainly composed of a chain between acid and amine functions being 6 carbon atoms long (hexamethylene chain) and a chain between acid and amine functions being 12 carbon atoms long (dodecamethylene chain), in particular derived from hexamethylene diamine (HMD) and dodecanedioic acid (DDDA). Other abbreviations in this context include “I” for a part derived from isophthalic (e.g.) acid or “T” for a part derived from terephthalic (e.g.) acid.

### DESCRIPTION OF THE DRAWING FIGURES

FIGS. 1a and 1b illustrates exemplary measurements of the particle size distribution of produced powder versus volume density;

FIG. 2 illustrates exemplary measurements of IR absorption in comparison to PA11 and PA12;

FIG. 3 illustrates thermal behavior and thermal properties of powders of the invention;

FIG. 4 is a photograph of a build bed;

FIGS. 5a and 5b are photographs of chained textiles produced using the powders of the present invention;

FIG. 6 is a photograph of a part of intricate geometry produced using the powders of the present invention;

FIG. 7 is a photograph of a half of an automotive fluid tank produced using the powders of the present invention; and

FIGS. 8a and 8b are photographs of fashion bracelets produced using the powders of the present invention.

### DETAILED DESCRIPTION OF THE INVENTION

One aspect of the present invention are copolyamide compounded powders, in the following sometimes named powders of the invention.

Another aspect of the present invention is a process for the production of the compounded copolyamide powders of the present invention.

Still another aspect of the present invention is the use of the compounded copolyamide powders of the present invention or the compounded copolyamide powders prepared according to the process of the present invention in selective laser sintering (SLS), high speed sintering (HSS), powder bed fusion, multi jet fusion and in 3-D printing, in rapid prototyping or rapid manufacturing, for additive manufacturing, and for production of high strength articles thereof.

In one embodiment of the present invention PA6.12 multipolymer and other high heat copolyamide powders that exhibit low curling, easy processing, general usability on industry standard laser sintering machines, high recyclability, specifically black colors with low curling and easy processing and improved IR heating control are provided.

In one embodiment of the present invention build parts processed in selective laser sintering in black color or high speed sintering in natural color with very high tensile and impact strength, high level of xyz-isotropy, high elastic properties and high stiffness even when conditioned, are provided.

Semi-aromatic PA6.12 is a useful resin for high temperature precision parts due to its high crystallinity and strength.

According to one embodiment of the present invention, a process for preparing compounded copolyamide powders, in particular semi-aromatic polyamide 6.12 copolyamide powders, is provided, consisting of or comprising the following process steps:
(i) mixing, preferably intimately mixing, and compounding copolyamide and additives, preferably additives other than reinforcing additives, as well as optionally colorants and/or pigments (color imparting compounds). In particular mixing is conducted in a mixing device, preferably in a melt mixing device such as an extruder, particularly at a temperature at least 10° C. above the melt temperature of said copolyamide, preferably 15° C. above the melt point temperature, and at most 80° C. above the melt temperature, in particular in a range from 20 to 60° C. above the melt temperature of the copolyamide;
(ii) cryogenic grinding of the compounded product of step (i) to produce a powder with a particle size distribution defined with the following boundaries:
   D10: 20-35 micron
   D50: 45-70 micron
   D90: <120 micron
   D99: <150 micron
and preferably the particle morphology is rounded or cuboid shaped (rounded or cuboid in this context preferably meaning an aspect ratio (largest diameter to smallest diameter) of about 1.5:1 to 1:1), in particular enabling the powder to flow through a 10 mm ASTM D1895-96,
(iii) post-addition of reinforcing additives to the ground product of step (ii), in particular via dry blending or melt extrusion,
(iv) optionally particle size adjustment of the products of step (ii) and/or (iii), in particular by sieving and/or air flow classification.

In one embodiment of the present invention the cryogenic milling of step (ii) can proceed with the following characteristics: −100° C. to −191° C. conveyor screw temperature. Further, preferred is −40° C. to −52° C. mill chamber temperature at a preferred throughput of 10 kg/h to 100 kg/h and a preferred a mill speed: 7000 rpm to 18000 rpm.

In one embodiment, the preferred mixing and compounding temperatures in step (i) are between 225° C. and 280° C.

Preferably, the particle size distribution in step (ii) is measured by dynamic light scattering; in one embodiment with 30 s pre-mixing at 1 wt % powder in water, shape factor: spherical L=1, on Mastersizer 3000, Malvern.

In one embodiment of the present invention the particle size adjustment of the products is done using
A) an air jet mill powder process alternatively an air classifier mill with a throughput of 5 to 30 kg/h with air inlet pressure of about 6 to 10, for example about 8 bar and wheel speed of about 5000 rpm to about 9000 rpm, for example around 7000 rpm, in particular thereby improving powder flow properties by removal of the fines fraction and improve sphericity,
B) a high speed blender to improve powder flowability through friction,
C) a polisher processor run at 5-10° C. below the peak melting temperature to improve powder flowability and sphericity; this process step is generally conducted after the cryogenic milling step and before or during air classifying.

It should be noted that in step (B) the improvement of flowability occurs in particular through agglomeration of fine particles to coarser particles and rounding of the sharp edges of particles and that in step (C) the removal of the fines fraction may be done through agglomeration of fine particles to coarser particles and rounding of the sharp edges of particles.

By the process of the present invention a more effective incorporation of additives can be achieved versus the known precipitated polymer powder route. Due to the better incorporation according to the invention, additives are better distributed across the substrate than by using other technologies.

It was surprisingly found in the context of the present invention that the combination of semi-aromatic polyamide 6.12 copolyamide copolymer, versatile additive incorporation technology such as one or combination of the following processing steps: compounding, dry blending and encapsulation/coating of particulates in particular embodiments, specific functional additives (non-exclusive list including non-conductive carbon black, anti-oxidants, reinforcing additives such as glass beads and/or fibers, flame retardants,) with a well chosen cryogenic milling and grading technique as above described results in powder with highly advantageous properties, in particular when used in SLS.

Copolyamide powders with aromatic content and compounded additive combinations are provided in one embodiment of the present invention, in particular these are highly thermally stable and easy to use black and natural powder versions. In the context of the copolyamides in this specification, the term “natural” describes the color of the copolyamide itself or with additives, but without colorants or pigments like carbon black.

In one embodiment of the invention the copolyamide compounded powders are PA6.12 multipolymer and other copolyamide powders that exhibit low curling, easy processing, general usability on industry standard SLS machines, in particular ones that are black colored with low curling and easy processing and improved IR heating control. In some embodiments these also have high recyclability; while in other embodiments these are intended for single use to produce 3D printed parts with highest mechanical performance for (semi-) structural use in aerospace or formula one applications.

In some embodiments of the present invention, final parts are prepared by SLS from the copolyamide compounded powders of the present invention in natural color and black with very good impact, elastic properties and high stiffness even when conditioned.

Examples of usable copolyamides are made by conventional copolymerization techniques and are copolymers of polyamide 6.12 (being a copolymer made from hexamethylenediamine and dodecanedioic acid), in particular copolymers comprising at least one aromatic component. Particularly the aromatic component is derived from isophthalic acid and/or terephthalic acid.

In one embodiment of the present invention, a copolymer of nylon 6.12, nylon 6I (hexamethylenediamine (HMD) and isophthalic acid) and nylon 6T (HMD and terephthalic acid) is employed.

In a further embodiment of the present invention, one particularly well suited copolyamide is one of nylon 6.12, nylon 6I (hexamethylenediamine (HMD) and isophthalic acid) and nylon 6T (HMD and terephthalic acid), in particular being prepared from HMD, DDDA (dodecanedioic acid), terephthalic acid and isophthalic acid and more particularly containing at least 9 mol % of aromatic comonomer (terephthalic acid and isophthalic acid, aromatic di-amine comonomer such as xylene diamine and/or phenylene diamine) with a non-stoichiometric ratio of amine end group to acid end groups of at least 1.05:1 or 2.5 mol % based on relative di-functional monomers concentration or a non-stoichiometric ratio of acid end group to amine end groups of at least 1.05:1 or 2.5 mol % based on relative di-functional monomers concentration; in particular a copolyamide having a relative solution viscosity of 1.4 to 2.0 according to IS0307.

Other examples for copolyamides usable in various embodiments of the present invention are those described in non-prepublished U.S. 62/101,450.

Examples for additives to be used in the present invention are:
heat stabilizers/anti-oxidants, of the hydroperoxide decomposer class in particular copper halides, such as in particular CuCl, CuCl₂, CuBr, CuBr₂, CuI, CuI₂, more particular iodo-bis(triphenylphosphin)copper and/or in combination with potassium iodine (KI) and or in combination with, heat stabilizers that act as catalysts in the polymerization of polyamides, effective on (1) the amine functionality such aromatic amine antioxidants and in particular 4,4′-Bis(α,α-dimethylbenzyl) diphenylamine or (2) the acid functionality such as sodium phosphites and phosphates; various alkyl phosphites and phosphates such as methyl, ethyl, propyl, and butyl phosphites and -phosphates; various phosphites and phosphates such as triphenyl phosphite and -phosphate, 3,9-Bis(2,4-di-tert-butylphenoxy)-2,4,8,10-tetraoxa-3,9-diphosphaspiro[5.5]undecan; alkali metal aryl phosphinates and various cycloalkyl and aralkyl phosphites and phosphate; the radical inhibitor class in particular hindered phenols such as N,N′-Hexamethylene bis[3-(3,5-di-t-butyl-4-hydroxyphenyl)propionamide] sold by BASF under the name Irganox® 1098 or pentaerythritol tetrakis(3-(3,5-di-tert-butyl-4-hydroxyphenyl) sold by BASF under the name Irganox® 1010, other examples are Bis (2,4-dicumylphenyl) pentaerythritol diphosphate, N,N′-Hexamethylene bis(3,5-di-t-butyl-4-hydroxyhydrocinnamamide); preferably the heat stabilizers/anti-oxidants are added in an amount of 0.5 wt % to 6 wt. % based on total formulation weight;
viscosity stabilizers which may also preferably have heat stabilizing and antioxidizing properties, in particular phosphorous-based compounds, such as acid and alkali metal dehydrogen phosphates, in particular 3,9-Bis(2,4-di-tert-butylphenoxy)-2,4,8,10-tetraoxa-3,9-diphosphaspiro[5.5]undecan, preferably the viscosity stabilizers are added in an amount of at least 0.2 wt % based on total formulation weight;
reinforcing additives and/or flow additives, in particular hydrophobic silica, aluminum oxide and/or glass beads in particular coated glass microbead such as 3000 CP03 from Potters UK Ltd., which are coated with a polyamide coupling agent such as amino-silanes; preferably the viscosity stabilizers are added in an amount of at least 2.5 wt % up to an amount of 40 wt % based on total formulation weight;
functional additives, in particular flame retardants, UV stabilizers, processing lubricants, e.g. polyethylene wax, in an amount of preferably at least 2 wt %, preferably 5 wt. % up to an amount of 20 wt. % based on total formulation weight.

In one embodiment, hydrophobic silica flow additives are preferably added at 0.02 wt % to 2.5 wt % providing improvements to dry flow, anti-caking behavior in short-term and long-term powder storage.

Additionally, at least one color imparting compound can be added to the compounded copolyamide powders of the present invention.

In particular these can be selected from the group consisting of carbon blacks and carbon black formulations in which the carbon black is employed with a polymeric base and mixtures thereof, wherein it should be understood that the different carbon blacks differ in their morphology, their primary particles size, their BET-surfaces etc, one commercially available example for a carbon black is a non-conductive mesoporous carbon black such as Printex® 80, [CAS#1333-86-4], whereas commercially available examples for carbon black formulations are for example AF-CARBON PA 950564 from Akro Plastic, RAW ROWALID PA 19413 or RAW ROWALID PA 19583 from Rowa. It should be noted here that carbon black also takes influence on the workability of the powders of the present invention in that is able to absorb heat from the laser sintering/3-D printing machine. Specifically, with carbon black an improvement in absorption of laser energy at wavelengths matching to CO₂ lasers at 10.6 micrometers when compared with typical PA12, PA6 and PA11 polymers can be achieved. As such carbon black is a preferred part of the powders of the invention in various embodiments of the present invention.

In some embodiments, low nucleating carbon black pigments from Rowa Masterbatch (a carbon black which is dispersed as fine particulate in the polymer matrix and does not act as secondary nucleating agent of the polymer matrix), in particular exhibiting no nucleating effect, are mixed into the formulation at specific minimum addition levels of 0.1 wt %, based on the total weight of the formulation, to provide black color and retaining wide delta T (the temperature difference between the onset temperature of melting and the onset temperature of crystallization) and desired low curl properties.

In one embodiment the black powder, in particular carbon black is added to the copolyamide powder in an amount of 0.05 wt % to 10% by weight, in particular 0.1 wt % to 1 wt %, more particular 0.1 wt % to 0.5 wt %. The carbon black may best be added in using a color masterbatch of PA6 and carbon black.

In one embodiment the black coloring additive may differ from non-conductive mesoporous carbon black in such as being of the nigrosine derivative such as ROWALID PA 19413 from Rowa Masterbatch or being a blend of organic red and green pigments such as SOLVAPERM G RED (Color Index CI: Solvent Red 135) and SOLVAPERM GSB GREEN (Color Index CI: Solvent Green 3) from Clariant.

In one embodiment of the present invention, when the resulting powders are black, and contain a long term heat stabilizer combination using copper compounds combined with Halides such as KBr (potassium bromide) that provide excellent long term retention or improvement to final part properties for use above 100° C., the powder can only be used one time in the SLS process to produce build parts with highest tensile, impact and flexural strength. The phosphorous based stabilizers in particular provide additional stability in process viscosity in repeated printing operations at high temperatures.

In one specific embodiment, when the powders of the present invention should later on be used as single use powders in SLS/3-D printing, the color imparting compound is carbon black.

The additives, in one embodiment of the present invention can be incorporated into the powder using high shear blending at a rate of 30 seconds to 5 minutes, at speed of 2000 rpm to 5000 rpm to a peak powder temperature of 110° C. with a post blending sieving operation after blending.

In one particular embodiment of the present invention the compounded copolyamide powders consist of: the copolyamide of nylon 6.12, nylon 6T and nylon 6I; 3,9-bis(2,4-di-tert-butylphenoxy)-2,4,8,10-tetraoxa-3,9-diphosphaspiro[5.5]undecan; iodo-bis(triphenylphosphin)copper; PA6; carbon black; aluminum oxide, hydrophobic fumed silica and glass beads.

With the present invention, from the use of the invention's powders, it was achieved to provide products having the desired increase in tensile and flexural modulus vs PA12 and PA11 commonly used in this industry. Moreover this was achieved within processing temperature of current SLS machine operating temperatures of 170-188° C.

Some of the unexpected and advantageous properties of the powders and products of the present invention are outlined in the tables 8 to 11, shown below.

The products of the present invention and made from the powders of the present invention have very desirable high tensile and flexural modulus vs PA12, PA11 and PA6 in particular when conditioned in high humidity and in some embodiments show the highly desired ability to be processed multiple times in SLS or related processes without the necessity for powder drying, which is opposite to PA6 powders in similar circumstances

In one embodiment of the process of the present invention, the copolyamide powders are ground while at the same time retaining supercooling crystalline polymer structure behavior after incorporation of the additives via melt extrusion. By supercooling crystalline polymer structure behavior it is meant here that the multiple process steps beyond the initial compounding step including cryogenic milling do not change the crystallization rate and the microcrystalline structure (spherulite density and spherulite morphology).

The powders of the present invention when processed show a very good surface aspect due to a suitable enthalpy of crystallization.

The powders of the present invention exhibit a wider processing window characterized into a delta T>45° C., i.e. a temperature difference between the onset temperature of melting and the onset temperature of crystallization larger than 45° C. than typically used SLS polyamide powders, providing advantages in wider processing window and lower tendency to process curling. Such powders of the present invention exhibit a peak melting temperature of 190-206° C. and a peak crystallization temperature of 145-148° C.

Generally, powders in SLS and related processes are heated with IR lamps, and typically absorption of radiation is increased with carbon content in black colors causing machine instability and problems to keep build bed temperature even across the entire flat area. Surprisingly, with the present invention these problems could be dealt with.

The melting range of the powders of the invention is within the capability of current SLS machines.

The powders of the invention usually show low absorption of moisture, which enable to produce 3 D printed parts which maintain their mechanical performance, for instance tensile strength, flexural strength, impact strength and elasticity modulus upon short to prolonged exposure to different humidity levels.

Some additional embodiments are the following:
a) The composition of the invention, in particular of example 1 (table 2, shown below) additionally comprising solid and hollow glass beads dry blended in at 1-50% by weight based on polymer compound weight.
b) The composition of the invention, in particular of example 1 (table 2, shown below) additionally comprising talc, chalk, TiO₂, barium sulfate (BaSO₄) compounded into the formulation prior to grinding at level of 0.1 wt % to 5 wt % based on polymer compound weight.
c) The composition of the invention, in particular of example 1 (table 2, shown below) additionally comprising reinforcing agents, glass beads, glass fiber, mineral (basalt) fibers, carbon fiber, aramide fiber, dry blended into the powder at use level between 2.5 wt % and 40 wt % based on polymer compound weight.
d) The composition of the invention, in particular of example 1 (table 2, shown below) additionally comprising electro-magnetic radiation EMR absorbers/conductive additives, colorants, halogen free flame retardants such as magnesium hydroxide, metal phosphinates, melamine polyphosphate, thermal breakers such as polyphenylene ether (PPE), UV stabilizers, dry lubricating additives (molybdenum disulfide, PTFE) at use level at less than 10 wt %, based on total polymer weight.
e) The composition of the invention, in particular of example 1 (table 2, shown below) additionally comprising
   I) solid and hollow glass beads dry blended in at 1-50% by weight based on polymer compound weight,
   II) talc, chalk, TiO₂, barium sulfate (BaSO₄) compounded into the formulation prior to grinding at level of 0.1 wt % to 5 wt % based on polymer compound weight,
   III) reinforcing agents, glass beads, glass fiber, mineral (basalt) fibers, carbon fiber, aramide fiber, dry blended into the powder at use level between 2.5 wt % and 40 wt % based on polymer compound weight, and
   IV) electro-magnetic radiation EMR absorbers/conductive additives, colorants, halogen free flame retardants such as magnesium hydroxide, metal phosphinates, melamine polyphosphate, thermal breakers such as polyphenylene ether (PPE), UV stabilizers, dry lubricating additives (molybdenum disulfide, PTFE) at use level at less than 10 wt %, based on total polymer weight.

With the powders of the present invention it is possible to make products/parts by 3D printing, such as by selective laser sintering or related processes like High Speed Sintering (HSS) with properties selected from the group consisting of tensile modulus of greater than 2500 MPa, tensile elongation at break in X-direction and Z-direction of approximately 45-50% and 10-13%, x,y,z-spatial anisotropy as low as 12% (measured on tensile strength) and mixtures thereof.

It was found in the context of the present invention that the powders of the present invention have a very wide processing window, low curling behavior and have the capability to be easier to use than the market leading products. It was also found that this is due to the supercooling behavior of the powders. An additional advantage of the powders of the invention is that they have a wide window for resistance to curling.

The powders of the present invention can be used with a wider temperature variation than other 3-D printing materials. This gives significant advantages to the user in many ways; one of the ways is that the material can be set at the temperature in the build zone of the machine between 179° C. and 189° C., that being a 10° C. window whereas standard materials generally operate at 173° C. with only a 2° C. or 3° C. window.

Further advantages were found in the processing of the powders of the present invention, namely in terms of power of laser used. Standard materials can for example use a laser power range of 10-30 W, whereas the powders of the present invention are able to work over a wider power range of for example 10 to 100 W without exhibiting or showing a tendency for shrinkage and distortion in the powder bed.

Other processing advantages shown by the powders of the present invention are also in relation to its behavior when cooling. The powders of the present invention are able to cool and retain their geometry in a more true fashion than standard materials. Other advantages in processing include a soft powder cake after cooling making it very easy to remove the powder dust from the surface of the SLS/3-D printed items. Such effects are usually attributed to the polymer having a high enthalpy.

In general the compounded copolyamide powders of the present invention have some unique features but share many standard features that are shown by powders well known in the art such as polyamide 12 or polyamide 11 powders.

Surprising results that could be achieved with the present invention are the following:
Large parts with very high stiffness, high level of isotropy in xyz build direction and high continuous use temperature (HDT A, CUT) can be produced.
The compounded copolyamide powders of the present invention show extremely high laser energy adsorption and thermal conductivity of powder, resulting in a potential reduction in the production cycle (heat/cooling cycle). Moreover, at the interface between the melting zone of the powder and the unmolten powder, the compounded copolyamide is able to maintain a better final surface quality through the lower “bleed” of energy to the surrounding powder. This is a significant advantage for final part quality, resolution and aspect.
The compounded copolyamide powders of the present invention can easily be processed (high flow powder for powder laying step on build bed, 100% use of build bed surface vs. 50% for PA12, no curling, no fines dust/fines loss).
Easy post-processing of manufactured parts (easy dedusting) is possible.
With some embodiments a re-use rate of >5 can be reached, while a re-use rate of 1-3 for PA6 and 5 for PA12 is common in the prior art.
Structurally sound massive parts with intricate geometry (low levels of air encapsulation during SLS production, low levels of voids created during cooling due to high compound crystallinity) and with high dimension stability (<0.1 mm) can be produced.
The number of offspec parts (due to high crystallization rate and high crystallinity, low shrinkage, low warpage and residual humidity<2% of compound) can be greatly reduced.
It is possible to produce functional parts with homogeneous black color (Compounded Black).
The high energy (Infra-red, thermal source) adsorption of the compounded copolyamide powders of the present invention allows to build parts at lower temperatures than expected.
The high energy (infra-red, thermal source) adsorption of the compounded copolyamide powders of the present invention also means that they can be processed on any type of SLS machines, from large professional machines to low energy, low temperature desktop SLS machines.

Exemplary embodiments of the invention are the following:

### Embodiment 1

Compounded copolyamide powder characterized in that it comprises or consists of
a) at least one semi-aromatic nylon 6 containing at least one aromatic component and at least one aliphatic component, in particular the nylon copolymer being present in at least 50 wt % in the composition, more particularly in an amount of 80 wt. % to 99.5 wt. %, more particularly 94 wt. % to 99 wt. %;
b) at least one heat stabilizer/antioxidant, in particular a phosphorous antioxidant and/or copper halide, more particular a copper iodide, particularly in an amount of 0.5 wt. % to 6 wt. %;
c) optionally at least one color imparting compound, in particular a pigment such as carbon black, particularly in an amount of 0 wt. % to 5 wt. %, more particularly 0.5 to 4 wt. %;
d) optionally at least one reinforcing additive and/or flow additive, in particular aluminum oxide and/or hydrophobic fumed silica and/or particular glass micro beads, particularly in an amount of 0 wt. % to 45 wt. %, more particularly in an amount of 2.5 wt % to 40 wt %;
e) optionally functional additives and in particular phosphonate-containing flame retardant, particularly in an amount of from 5 to 20 wt.-%;
   the percentages being based on the entire compounded copolyamide powder, representing 100 wt.-%.

### Embodiment 2

Powder according to embodiment 1, characterized in that the nylon copolymer is a copolymer of nylon 612, nylon 6I (hexamethylenediamine (HMD) and isophthalic acid) and nylon 6T (HMD and terephthalic acid).

### Embodiment 3

Powder according to embodiment 1 or 2, characterized in that the nylon copolymer is a copolymer of nylon 612, containing at least 9 mol % or at least 10 wt % of aromatic comonomer, in particular terephthalic acid and isophthalic acid, aromatic diamine comonomers particularly xylene diamine and/or phenylene diamine, with a non-stoichiometric ratio of difunctional amine to acid end groups of at least 2.5 mol % and in particular having a relative solution viscosity of 1.4 to 2.0 according to IS0307.

### Embodiment 4

Powder according to embodiment 1, characterized in that the nylon copolymer is a copolymer of nylon 6, such as but not restricted to nylon 64, nylon 610 and nylon 66.

### Embodiment 5

Powder according to any one of embodiments 1 to 4, characterized in that the melting point of the nylon copolymer is above 185° C. and the processing window, the difference between the onset temperature on melting and the onset temperature of crystallization is higher than 45° C.

### Embodiment 6

Powder according to any one of embodiments 1 to 5, characterized in that the powder is black.

### Embodiment 7

Powder according to any one of embodiments 1 to 6, characterized in that the heat stabilizer is iodo-bis(triphenylphosphin)copper.

### Embodiment 8

Powder according to any one of embodiments 1 to 7, characterized in that the antioxidant is 3,9-Bis(2,4-di-tert-butylphenoxy)-2,4,8,10-tetraoxa-3,9-diphosphaspiro[5.5]undecan.

### Embodiment 9

Powder according to any one of embodiments 1 to 8, characterized in that the color imparting compound is carbon black.

### Embodiment 10

Powder according to any one of embodiments 1 to 9, characterized in that it has supercooling crystalline polymer structure behavior.

### Embodiment 11

Powder according to any of embodiments 1 to 10, characterized in that they have at least one of the following properties, particularly two of those and more particularly all of those:
a D50 between 45 and 85 microns, in particular 45-55 microns, and a D99 below 150 microns;
a dry 10 mm flow funnel flowability between 16 seconds and 50 seconds;
a bulk density of 0.4-0.6 g/cm3 according to ASTM D1895-96, and
a particle morphology being rounded or cuboid shape enabling the powder to flow through a 10 mm ASTM D 1895-96.

### Embodiment 12

Powder according to any one of embodiments 1 to 11, characterized in that is prepared by the following steps:
(i) melt mixing and compounding the copolyamide, additives other than reinforcing additives and optionally colorants and/or pigments, in particular in an extruder;
(ii) cryogenic grinding of the compounded product of step (i) to produce a powder with adequate particle size distribution and particle morphology, characterized in that the particle size distribution is defined with the following boundaries:
   D10: 20-35 micron
   D50: 45-70 micron
   D90: <120 micron
   D99: <150 micron
   and the particle morphology is rounded or cuboid shape, in particular enabling the powder to flow through a 10 mm ASTM D1895-96 flow funnel;
(iii) post-addition of reinforcing additives to the ground product of step (ii), in particular via dry blending or melt extrusion;
(iv) optionally particle size adjustment of the products of step (ii) and/or (iii), in particular by sieving and/or air flow classification.

### Embodiment 13

Powder according to any one of embodiments 1 to 12 characterized in that it comprises or consists of
a) at least one semi-aromatic nylon 6 containing at least one aromatic component and at least one aliphatic component t, in particular the nylon copolymer being present in at least 50 wt % in the composition, more particularly in an amount of 80 wt. % to 99.5 wt. %, more particularly 94 wt. % to 99 wt. %;
b) at least one heat stabilizer/antioxidant, in particular a phosphorous antioxidant and/or copper halide, more particular a copper iodide, particularly in an amount of 0.5 wt. % to 6 wt. %;]
c) optionally at least one color imparting compound, in particular a pigment such as carbon black, particularly in an amount of 0 wt. % to 5 wt. %, more particularly 0.5 to 4 wt. %;
d) optionally at least one reinforcing additive and/or flow additive, in particular aluminum oxide and/or hydrophobic fumed silica and/or particular glass micro beads, particularly in an amount of 0 wt. % to 45 wt. %, more particularly in an amount of 2.5 wt % to 40 wt %;
e) optionally functional additives and in particular phosphonate-containing flame retardant, particularly in an amount of from 5 to 20 wt.-%;
   the percentages being based on the entire compounded copolyamide powder, representing 100 wt.-%, in particular for 3D printing and in particular selective laser sintering, high speed sintering (HSS), powder bed fusion, multi jet fusion, additive manufacturing, further characterized in that it is a single-use powder.

### Embodiment 14

Powder according to any one of embodiments 1 to 13, characterized in that
the amount of particles having an average diameter below 20 micron is less than 10 vol. %, in particular less than 5 vol. %,
   and/or
they have a wider temperature of usability in standard SLS machines than conventional powders, in particular a window of 40° C. to 50° C., more particularly 45° C.,
   and/or
parts, in particular soft cakes, prepared with them have improved depowdering properties,
   and/or
parts prepared from them are stiffer than parts prepared from PA6 once conditioned in moisture.

### Embodiment 15

Process for preparing compounded copolyamide powders, particularly suitable for additive manufacturing processes such as selective laser sintering and high speed sintering, according to any of embodiments 1 to 14, characterized in that the process comprises or consists of the following steps:
(i) melt mixing and compounding copolyamide, additives, preferably other than reinforcing additives and optionally colorants and/or pigments, in a mixing device, in particular in an extruder;
(ii) cryogenic grinding of the compounded product of step (i) to produce a powder with a particle size distribution defined with the following boundaries:
   D10: 20-35 micron
   D50: 45-70 micron
   D90: <120 micron
   D99: <150 micron
   and the particle morphology is rounded or cuboid shape, in particular enabling the powder to flow through a 10 mm ASTM D1895-96 flow funnel;
(iii) post-addition of reinforcing additives to the ground product of step (ii), in particular via dry blending or melt extrusion;
(iv) optionally particle size adjustment of the products of step (ii) and/or (iii), in particular by sieving and/or air flow classification.

### Embodiment 16

Process according to embodiments 15, characterized in that the cryogenic milling of step (ii) proceeds with the following characteristics: −100° C. to −191° C. conveyor screw temperature, −40° C. to −52° C. mill chamber temperature; throughput of 10 to 100 kg/h, mill speed: 7000 to 18000 rpm, in particular 10.200 rpm.

### Embodiment 17

Parts made from powders according to any one of embodiments 1 to 14 or by a process according to any one of embodiments 15 or 16.

### Embodiment 18

Use of the compounded copolyamide powders according to any of embodiments 1 to 14 or the compounded copolyamide powders prepared according to any of embodiments 15 or 16 in additive manufacturing, selective laser sintering (SLS), high speed sintering (HSS), powder bed fusion, multi jet fusion, for rapid prototyping or rapid manufacturing, for production of high strength articles thereof by any of the mentioned 3-D printing processes, in particular parts for aerospace applications or formula one vehicles.

The invention will now be described on the basis of the following non-limiting examples.

### EXAMPLES

### 1. Compounds

### 1.1 Formulation of PA6.12 Natural and Black Compounds

A copolymer of nylon 6.12, nylon 6I (hexamethylenediamine (HMD) and isophthalic acid) and nylon 6T (HMD and terephthalic acid) was prepared from HMD, DDDA (dodecanedioic acid), terephthalic acid and isophthalic acid in a conventional manner; in particular as described in non-prepublished U.S. 62/101,450, paragraph [0037], and formed into pellets, then compounded and further ground into a powder using conventional techniques.

The ingredients set out in the table 1 below were mixed together by compounding into an extruder to produce a PA 6.12 powder of natural color.

TABLE 1

| | Supplier | Use level [wt. %]* |
|---|---|---|
| PA 6.12 SVPX-120^{[1]} | Jarden | 98.25-98.75 |
| Doverphos S 9228^{[2]} | Dover Chemical | 0.1-1 |
| AOS Songnox 1098FF PHE^{[3]} | Songwon | 0.1.1 |
| BRUGGOLEN ® H 320^{[4]} | Brüggemann | 0.02-1 |
| PETS Ligalub 50PE^{[5} | Peter Greven | 0.1-0.3 |

*Total = 100%
^{[1]}= corresponding to the above preparation-description
^{[2]}= solid heat stabilizer/anti-oxidant Bis (2,4-dicumylphenyl)pentaerythritol diphosphate
^{[3]}= heat and processing stabilizer/antioxidant N,N′-Hexamethylene bis(3,5-di-t-butyl-4-hydroxyhydrocinnamamide)
^{[4]}= heat and processing stabilizer/antioxidant, copper idodide
^{[5]}= polyethylene wax used as processing lubricant

The ingredients set out in the table 2 below were mixed together by compounding into an extruder to produce a PA 6.12 powder of black color.

TABLE 2

| | Supplier | Use level [wt. %]* |
|---|---|---|
| PA 6.12 SVPX-120^{[1]} | Jarden | 97.25-98.25 |
| OAD BRUGGOLEN H 175^{[2]} | Brüggeman | 0.75-1 |
| BRUEGGOLEN H3376^{[3]} | Brüggeman | 0.5-0.75 |
| RAW ROWALID PA 19583^{[4]} | Rowa | 0-1 |

*Total = 100%
^{[1]}= corresponding to the above preparation-description
^{[2]}= heat and processing stabilizer/antioxidant (3,9-Bis(2,4-di-tert-butylphenoxy)-2,4,8,10-tetraoxa-3,9-diphosphaspiro[5.5]undecan)
^{[3]}= heat stabilizer (Iodo-bis(triphenylphosphin)copper)
^{[4]}= PA6, 30 wt % carbon black

The ingredients set out in the table 3 below were mixed together by compounding into an extruder to produce a PA 6.12 powder of black color

TABLE 3

| | Supplier | Use level [wt. %]* |
|---|---|---|
| PA 6.12 SVPX-120^{[1]} | Jarden | 97.25-98.25 |
| OAD BRUGGOLEN H 175^{[2]} | Brüggeman | 0.75- |
| BRUEGGOLEN H3376^{[3]} | Brüggeman | 0.5-0.75 |
| AF-CARBON PA 950564^{[4]} | Akro Plastic | 0-1 |

*Total = 100%
^{[1]}= corresponding to the above preparation-description
^{[2]}= heat and processing stabilizer/antioxidant (3,9-Bis(2,4-di-tert-butylphenoxy)-2,4,8,10-tetraoxa-3,9-diphosphaspiro[5.5]undecan)
^{[3]}= heat stabilizer (Iodo-bis(triphenylphosphin)copper)
^{[4]}= carbon black in PA

A PA6.12 black compound with 600 ppm residual moisture was obtained.

Similarly another method to produce a compounded PA6.12 black is to compound the following formulation:

TABLE 4

| | | Use |
|---|---|---|
| | Supplier | level [wt. %]* |
| PA 6.12 SVPX-120^{[1]} | Jarden | 97.25-98.25 |
| OAD BRUGGOLEN H 175^{[2]} | Brüggeman | 0.75-1 |
| BRUEGGOLEN H3376^{[3]} | Brüggeman | 0.5-0.75 |
| RAW ROWALID PA 19413^{[4]} | Rowa Masterbatch | 0-1 |

*Total = 100%
^{[1]}= corresponding to the above preparation-description
^{[2]}= heat and processing stabilizer/antioxidant (3,9-Bis(2,4-di-tert-butylphenoxy)-2,4,8,10-tetraoxa-3,9-diphosphaspiro[5.5]undecan)
^{[3]}= heat stabilizer (Iodo-bis(triphenylphosphin)copper)
^{[4]}= PA6, 30 wt % C.I. Solvent Black 7 (nigrosine based)

Similarly another method to produce a compounded PA6.12 black is to compound the following formulation:

TABLE 5

| | Supplier | Use level [wt. %]* |
|---|---|---|
| PA 6.12 SVPX-120^{[1]} | Jarden | 94.25-97.25 |
| OAD BRUGGOLEN H 175^{[2]} | Brüggeman | 0.75-1 |
| BRUEGGOLEN H3376^{[3]} | Brüggeman | 0.5-0.75 |
| SOLVAPERM G RED | Clariant | 0-2 |
| SOLVAPERM GSB GREEN | Clariant | 0-2 |

*Total = 100%
^{[1]}= corresponding to the above preparation-description
^{[2]}= heat and processing stabilizer/antioxidant (3,9-Bis(2,4-di-tert-butylphenoxy)-2,4,8,10-tetraoxa-3,9-diphosphaspiro[5.5]undecan)
^{[3]}= heat stabilizer (Iodo-bis(triphenylphosphin)copper)

### 1.2 Processing

For the compounding step a twin-screw extruder (SZK 26) with the following setting process parameter settings has been used:

TABLE 6

| information on the extruder machine | | 26/3 |
|---|---|---|
| supplier: | | Coperion GmbH |
| model: | | ZSK 26 Mc |
| L/D: | | 44 |
| Power installed (kW): | | <40 |
| type of pelletizing: | | Strand/underwater pelletized |
| | | granulate |
| side feeder position(s)/Barrel No.: | | 4, 7/5 |
| Other Equipment | | ZSEG^{[1]}, FET^{[2]}, liquid dosing |
| (ZSEG/FET/Stuffer . . . ): | | |
| Machine Settings | | |
| screw speed | [rpm] | 300-600 |
| Throughput | [kg/h] | 3-60 |
| Torque | [%] | 80-100 |
| melt temperature | [° C.] | 250-260 |
| (machine data) | | |
| pressure at the die | [bar] | 15-25 |
| specific energy | [kWh/kg] | 200-300 |
| (mechanical) | | |
| Barrel temperature | [° C.] | 120-245 |
| temperature die plate [° C.] | [° C.] | 225-255 |

^{[1]}= ZSEG = twin screw side devolatilization unit
^{[2]}= FET = Feed Enhancement Technology Unit

### 2. Micronization Process

The product of example 1 was then put into a small cryogenic counter-rotating pin mill with fluted pins and continuous milling proceeded with the following characteristics: −100° C. to −191° C. conveyor screw temperature, −40° C. to −52° C. mill chamber temperature; throughput of 25-50 kg/h, a mill speed: 18000 rpm (a continuous milling process—particles residence time is less than 180 seconds).

The milled product was then sieved through a 106 micron sieve mesh on rotary.

While in-line, an inorganic flow aid, e.g. hydrophobic fumed silica such as those available under the tradename Aerosil from Evonik or aluminum oxide or zinc oxide at 0.02-1 wt %, was added.

Then it was dry blended with 2.5-40 wt % glass beads by addition to the coarse powder fraction.

The resulting product was processed on an off line air classifier (Hosokawa Alpine) at 20-50 kg/h throughput, 4000 rpm to 7000 rpm wheel rotor speed, 5 bar inlet pressure, 20 mbar air counter-pressure, to remove 13-27 wt % fine particles below 30 μm (residence time below 60 seconds).

An exemplary powder composition prepared according to this procedure is given in table 2 below.

TABLE 7

| | Use Level (wt %)* |
|---|---|
| Product from example 1 | 94.50-98.98 |
| Aluminum oxide (from Evonik) | 1-2 |
| Aerosil R972^{[1]} (from Evonik) | 0.02-1 |
| Glass beads^{[2]} | 0-2.5 |

*Total = 100%
^{[1]}= hydrophobic fumed silica aftertreated with dimethyldichlorosilane, having a specific surface area (BET) of 90-130 m²/g;
^{[2]}= treated with an amino-silane coupling agent to enhance bonding with the PA6.12 polymer resin

### 2.3 Test Results

### 2.3.1. Particle Size Distribution of Produced Powder

The following particle size distribution of powder of the invention in comparison to benchmarks are provided in Table 8.

TABLE 8

| | | | Particle Size Distribution | | | |
|---|---|---|---|---|---|---|
| | | | Fine | | | |
| | | | fraction | | | |
| | | Bulk | below | | | |
| | Dry Flow | density | 20 μm | D10 | D50 | D90 |
| Property | (s/100 g) | (g/100 cc) | (vol %) | (μm) | (μm) | (μm) |
| Test Method | ISO EN | ASTM | [1] | [2] | [2] | [2] |
| | 6189 | D1895 | | | | |
| PA12 - | 25 | 44 | NA | 36 | 54 | 80 |
| Natural | | | | | | |
| PA2200 | | | | | | |
| Balance | | | | | | |
| (EOS) | | | | | | |
| PA11-Arkema | 63.7 | 52.6 | 0 | 27 | 50 | 86 |
| Black | | | | | | |
| Product from | No flow* | 44.1 | 9-10 | 21 | 57 | 104 |
| example 2, | | | | | | |
| unsieved | | | | | | |
| Air classified | 32.4 | 44.9 | 3-4 | 31 | 63 | 106 |
| product from | | | | | | |
| example 2 | | | | | | |

[1] = measured using an Alpine air jet sieve
[2] = measured using a Mastersizer 3000 from Malvern on dry powders

The particle size distribution of the unsieved product from example 2, measured by laser scattering using a Mastersizer 3000 from Malvern on dry powders display a monomodal particle size distribution with a small volume fine fraction below 20 microns.

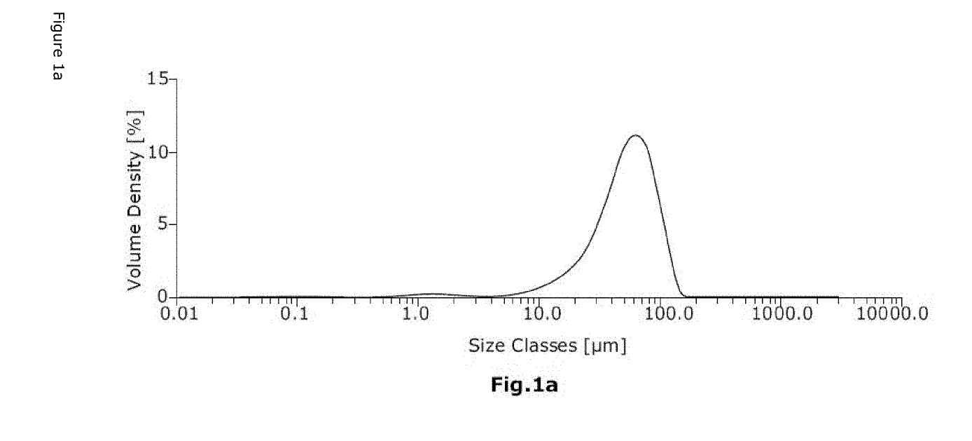

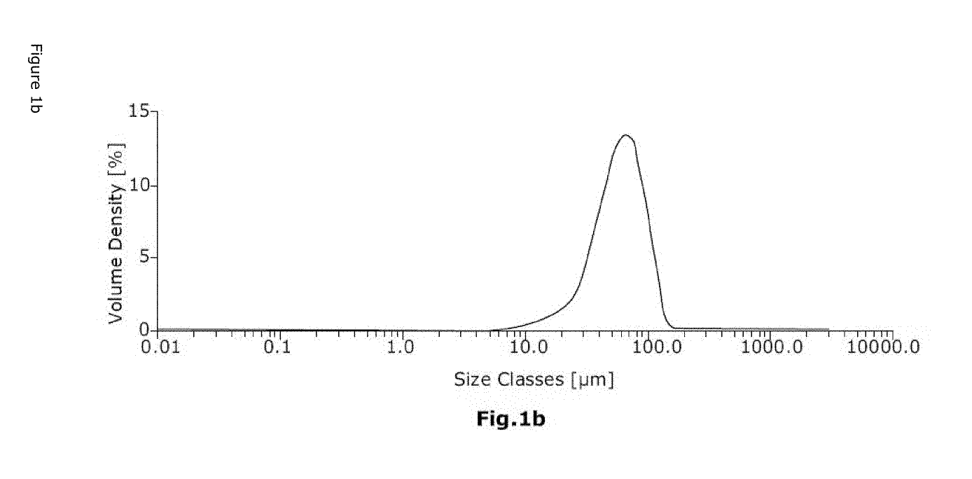

Exemplary measurements were done and are shown FIG. 1a and FIG. 1b.

### 2.3.2. IR Spectrum

The powders of Example 1 in natural (table 1) and black (table 2) compounded color in the typical wavelength range of CO₂ laser show similar IR adsorbance to PA11 and PA12.

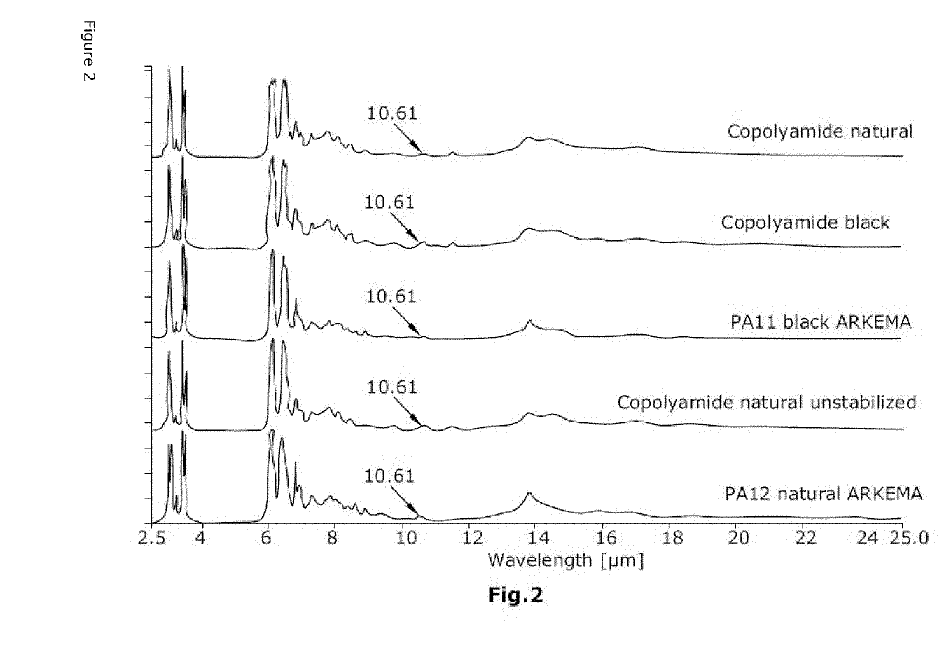

Exemplary measurements were done and are shown FIG. 2, which shows the IR adsorption of powders of Example 1 in (table 1) and black (table 2) compounded color in comparison to PA12 Natural and PA11 Black.

### 2.3.3 Thermal Capacity

### 2.3.4 Thermal Properties of Powder Processed by Laser Sintering

The thermal behavior and thermal properties of powders of the invention processed by selective laser sintering to form ISO tensile bars and the influence of the residual humidity of the powder of the invention on crystallization and melting peak have been measured by DSC (Mettler Toledo, heating rate q=10 K/min). These have been measured by DSC. In such DSC measurements, the DSC can be seen to have two heating curves. In such a measurement, a first heating relating to the crystalline melting behavior of the material based on its thermal history for the extrusion process, with the peak melting point having been shown to be approximately 201° C., with the onset of melting at approximately 187° C. A second heating relating to the crystalline melting behavior of the material based on its thermal history in the DSC in the first cooling and was lower at 187° C. with the onset of melting at 176° C. The difference between crystalline melting temperature first heat and crystalline cooling temperature first cool in this example was 53° C. This wide difference can be related to the wide processing window and good anti-curling processing behavior of the material. The difference between the peak melting point for the two heating curves is related to the historical difference in cooling rate which has the effect to change the crystalline melting point of the copolyamide.

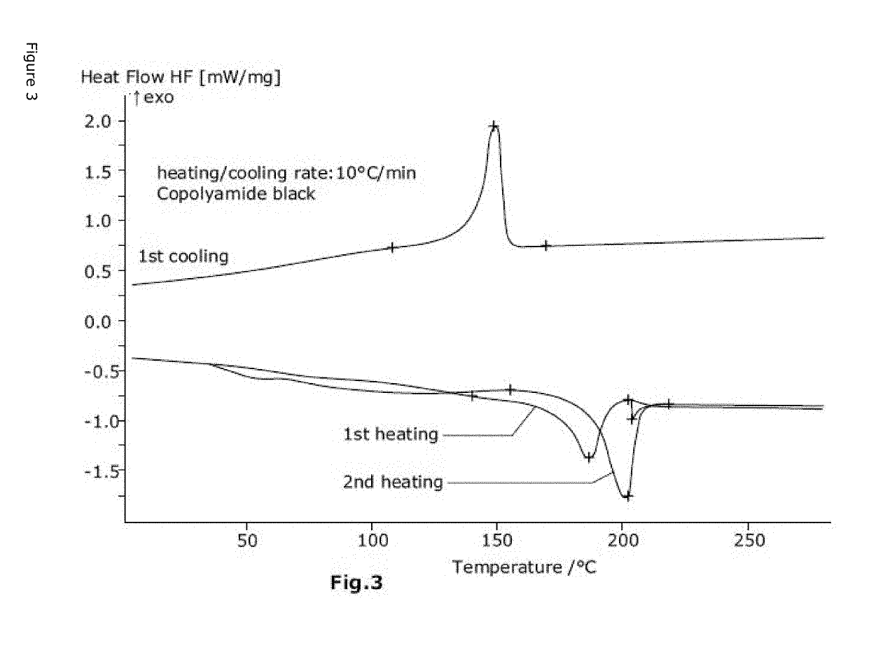

One exemplary representation (of the various conducted) of such measurements for these results being done is shown in FIG. 3.

### 3. Production of Built Part by Laser Sintering Process

### 3.1 Test Results on ISO Bars

The product of example 2 was used in a selective laser sintering process (SLS) on a SLS large bed machine (Prodways, Promaker 4000X), 400×400×600 mm bed, and preheated powder feed station was used. All tests were done in 99.9% N₂ atmosphere. The parameters were as follows:
2 hour warm up from ambient temperature to 180° C. at heating ramp: 12° C./min
processing time in the build chamber: 4-10 hours
4-10 hour cool down time at 0.25-1° C./min
build speed in z-axis: 1.2 cm per hour
Laser powder: 35-75 W
Laser scanning speed: 3 m/s to 12.7 m/s

### 3.1.1. Powder Bed Laying

Build beds to produce ISO bars were made with the product of example 2. These had a smooth flat powder bed and clean lines around laser irradiated particles to produce well formed ISO bars.

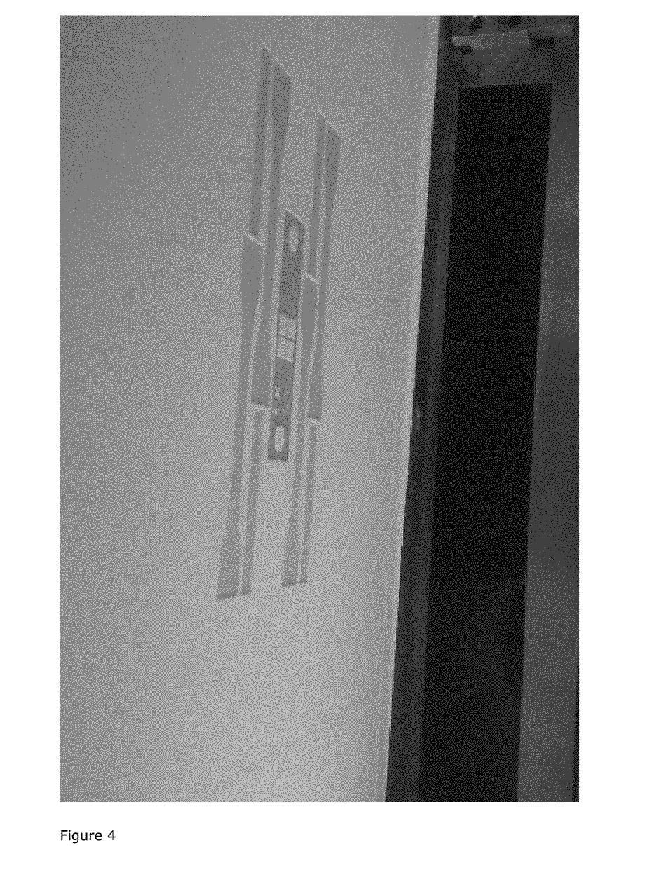

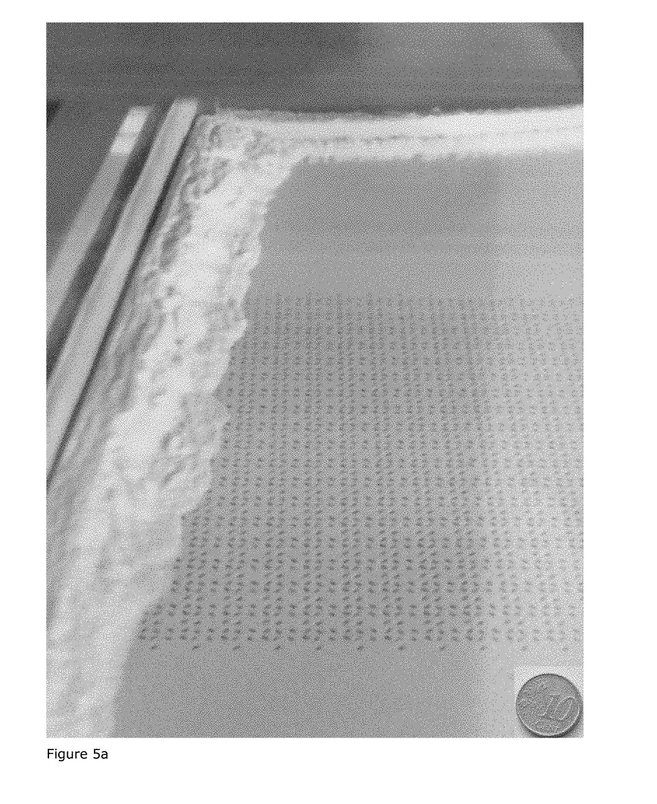

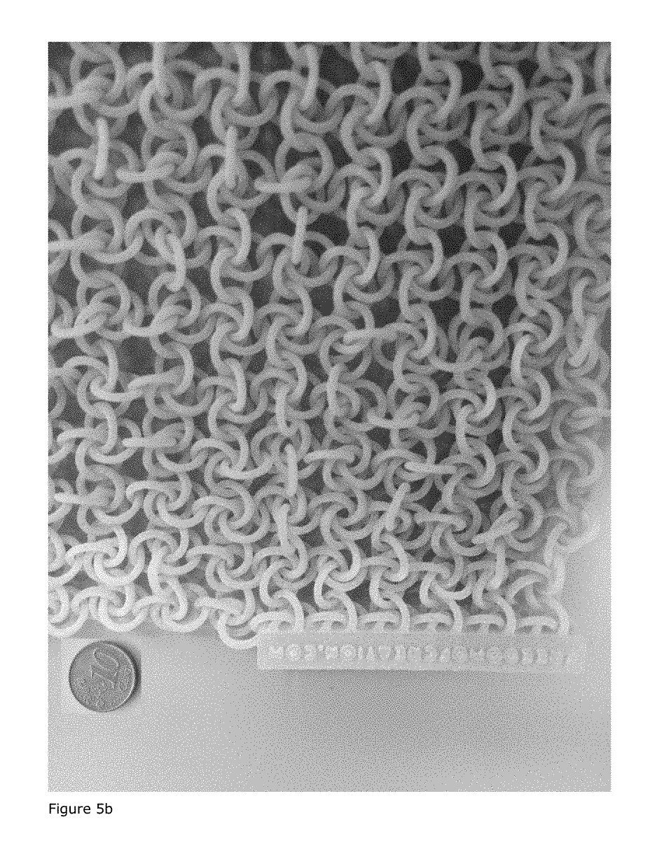

An exemplary photograph of a build bed during operation to produce ISO bars was taken and is shown FIG. 4.

### 3.1.2. Mechanical Properties of SLS Produced ISO Bars

Table 9 summarizes the tensile strength at yield and at break measured at RH45%, at 10 mm/min deformation rate according to ISO 527 and the flexural strength at yield and at break measured according to ASTM D791 at 50 cm/min deformation rate on flat ISO bars (ISO bars produced I the x-direction) by produced SLS at 35 W laser power (laser hatching spacing of 0.2 mm) and 181° C. build chamber temperature using powders of Example 1. The results are surprising in that the produced ISO bars exhibit very high flexural modulus of over 2100 MPa and elongation at break of 17.8%.

TABLE 9

| Tensile Strength^{[1]} | | | | | | |
|---|---|---|---|---|---|---|
| | Tensile | Elon- | Tensile | Elon- | Flexural Strength^{[2]} | |
| | strength | gation | strength | gation | Deflec- | Flexural |
| | at yield | at yield | at break | at break | tion | Modulus |
| | (MPa) | (MPa) | (MPa) | (MPa) | (mm) | (MPa) |
| Average | 63.5 | 13.8 | 60.2 | 17.8 | 8.84 | 2138 |
| Standard | 0.9 | 0.6 | 2.4 | 4.1 | 0.4 | 53 |
| Deviation | | | | | | |
| Cv(%) | 1.5 | 4.2 | 3.9 | 23.1 | 2.0 | 2 |

^{[1]}Tensile strength were measured in quintuplet on 4.2 mm thick ISO bars produced at 35 W laser energy in x-direction (flat) of the products of Example 1 on an INSTRON universal hydraulic tensiometer at 10 mm/min according to ISO527.
^{[2]}Flexural strength were measured in quintuplet on 4.2 mm thick, 10.2 mm wide ISO bars produced at 35 W laser energy in x-direction (flat) of the products of Example 2 on an INSTRON universal hydraulic tensiometer at 1.78 mm/min with a 66.5 mm support span according to ASTM D791.

Table 10 summarizes the tensile strength at yield and at break measured at 5 mm/min deformation rate according to ISO 527 on flat ISO bars produced in the x-direction by SLS at 25 W laser power and at varying build chamber temperature using powders of Example 1 (Table 1). The results are surprising in that the produced ISO bars exhibit high elongation at break, i.e. above 14% at 10 mm/min deformation rate

TABLE 10

| | Tensile | | Tensile | |
|---|---|---|---|---|
| | strength at | Elongation at | strength at | Elongation at |
| | yield (MPa) | yield (MPa) | break (MPa) | break (MPa) |
| | 188° C. build chamber, 4000 mm/s laser scanning speed | | | |
| Average | 62.4 | 16.2 | 48.4 | 50.0 |
| Standard | 0.5 | 0.4 | 2.4 | 5.0 |
| Deviation | | | | |
| Cv (%) | 0.4 | 2.2 | 4.9 | 10.0 |
| | 188° C. build chamber, 5000 mm/s laser scanning speed | | | |
| Average | 62.7 | 15.3 | 51.6 | 46.0 |
| Standard | 0.7 | 0.2 | 2.2 | 2.0 |
| Deviation | | | | |
| Cv (%) | 1.1 | 1.4 | 4.2 | 3.0 |
| | 186° C. build chamber, 5000 mm/s laser scanning speed | | | |
| Average | 62.7 | 15.4 | 55.1 | 43.0 |
| Standard | 0.7 | 0.2 | 3.4 | 7.0 |
| Deviation | | | | |
| Cv (%) | 1.1 | 1.5 | 6.1 | 16.0 |

[1] = Tensile strength were measured in quintuplet on 4.2 mm thick ISO bars produced.

Table 11 summarizes the tensile and flexural strength at yield and at break measured at RH45%, at 1 mm/min deformation rate according to ISO 527 on flat ISO bars produced in the x-direction by SLS at 65 W laser power and 183° C. build chamber temperature using powders of Example 1 (Table 1). The results are surprising in that the produced ISO bars exhibit a high Young's modulus, i.e. above 2500 MPa.

TABLE 11

| | Maximal | | | | Percentage |
|---|---|---|---|---|---|
| | tensile | Young's | Strain at | Elongation | of |
| | strength | modulus | break | at break | elongation |
| Sample # | [N] | (MPa) | (MPa) | (mm) | at break |
| 1 | 2535.92 | 2418.07 | 58.24 | 6.73 | 13.47 |
| 2 | 2583.60 | 3011.55 | 57.71 | 6.24 | 12.48 |
| 3 | 2498.30 | 2543.10 | 57.70 | 6.24 | 12.49 |
| 4 | 2511.78 | 2414.09 | 59.88 | 6.57 | 13.15 |
| Mean Value | 2532.40 | 2596.70 | 58.38 | 6.45 | 12.90 |

Table 12 summarizes the tensile and flexural strength at yield and at break measured at RH 45%, at 10 mm/min deformation rate according to ISO 527 on flat ISO bars produced in the x, y and z-directions by SLS at 19 W laser power and 175° C. build chamber temperature using powders of Example 1 (Table 1). The results are surprising in that the produced ISO bars exhibit an x,y,z-anisotropy in tensile strength at yield lower than 12.5% and lower than 8% for the elongation at break.

TABLE 12

| | Tensile | | Tensile | |
|---|---|---|---|---|
| | strength at | Elongation at | strength at | Elongation at |
| | yield (MPa) | yield (MPa) | break (MPa) | break (MPa) |
| | Build x-direction | | | |
| Average | 51.9 | 12.6 | 51.9 | 12.6 |
| Standard | 3.5 | 1.4 | 3.5 | 1.4 |
| Deviation | | | | |
| Cv (%) | 6.7 | 11.1 | 6.7 | 11.1 |
| | Build in y-direction | | | |
| Average | 59.1 | 16.4 | 54.3 | 33.8 |
| Standard | 1.8 | 0.6 | 2.3 | 4.7 |
| Deviation | | | | |
| Cv (%) | 3.0 | 5.8 | 4.2 | 14.0 |
| | Build in z-direction | | | |
| Average | 59.0 | 16.4 | 56.3 | 24.3 |
| Standard | 2.3 | 0.6 | 3.2 | 5.4 |
| Deviation | | | | |
| Cv (%) | 4.0 | 3.5 | 5.7 | 22.0 |

[1] = Tensile strength were measured in quintuplet on 4.2 mm thick ISO

Results are additionally remarkable due to their wide laser power variation and their wide temperature variation, from 175° C. to 188° C. build chamber temperature. This is generally not regarded as normal in SLS processing of typical market leading materials such as EOS PA2200. It is regarded in the SLS industry that typical results from this market leading material PA2200 would be 4-8% elongation at break with lower rigidity (flexural modulus of 1500 MPa and laser power range of typically 20 W).

### 3.2. Decorative and Semi-Structural Parts Produced by SLS

The powders of the present invention were used to produce flat parts of intricate geometry, like chained textiles for the fashion industry by SLS on EOS P100 machine with a build chamber temperature of 176° C., at 19 W laser power (laser hatching spacing of 0.2 mm). The part resolution and tensile strength of the unit rings, the toughness of the fabrics are far superior to fabrics produced with conventional PA12 powder.

Exemplary photographs of such parts were taken during production (FIG. 5a) and after cooling (FIG. 5b) (the 10 cent coin being shown for size comparison).

Hollow parts of intricate geometry were produced by SLS on EOS P100 machine with a build chamber temperature of 181° C. at 45 W laser power (laser hatching spacing of 0.2 mm) built upright with open end upwards with a powder of example 1, table 1. The resulting parts displayed upon cooling and dedusting an easy depowdering, characterized in that one light tap when upturned on a hard surface was sufficient to remove all the powder trapped inside the parts. This is the optimum result for these test parts. Also surprisingly, when this process was repeated using 181° C. build chamber temperature, 60 W laser energy and 0.28 mm laser hatching spacing the same results were achieved.

An easy depowdering was possible for the same parts produced with a black powder of example 1, table 2 in a broad range of build chamber temperature (180-189° C.) and laser energy density varying from 0.0225 J/mm² to 0.0301 J/mm². Same parts produced with a conventional PA12 powder display a difficult depowdering, under normal running conditions in the same SLS machine for a temperature variation of more than 0.5° C. from the optimum build chamber temperature.

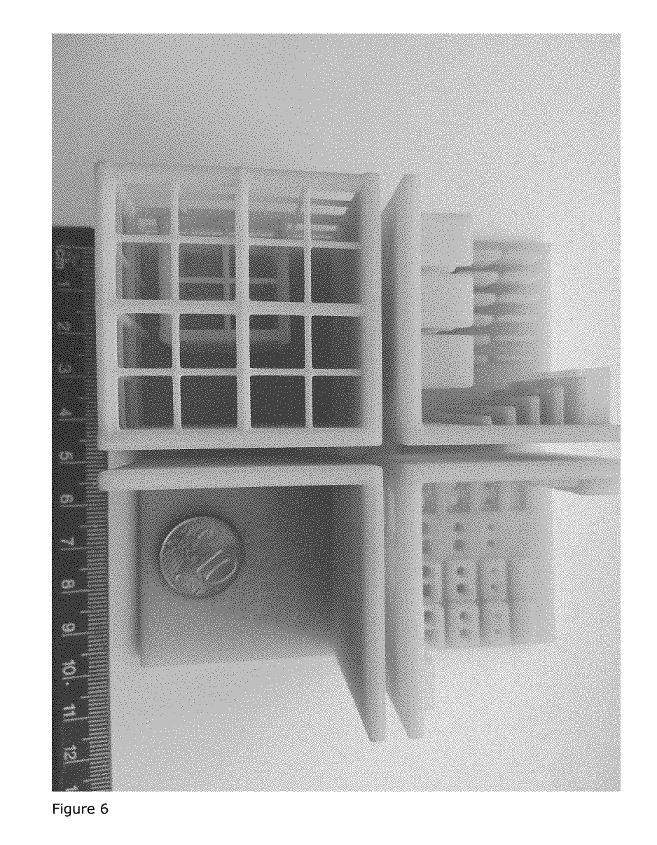

An exemplary photograph of a part of intricate geometry was taken and is shown in FIG. 6 (the 10 cent coin being shown for size comparison).

Removed parts were lightly brushed with a standard paintbrush bristle to remove nearly all loose powder. Surprisingly and advantageously the surface was clean and virtually free from all dust after this treatment.

In addition the produced part displays high spatial resolution with fine 0.7 mm bars moreover which were tough enough to withstand significant stress applied by the depowdering devices.

Halves of automotive fluid tanks with 6 mm walls were produced by SLS on Prodways, Promaker 4000X machine with a build chamber temperature of 183° C., at 65 W laser power (laser hatching spacing of 0.2 mm) using black powder of example 1. The resulting parts were not prone to curling during production and displays high dimensional stability and low porosity

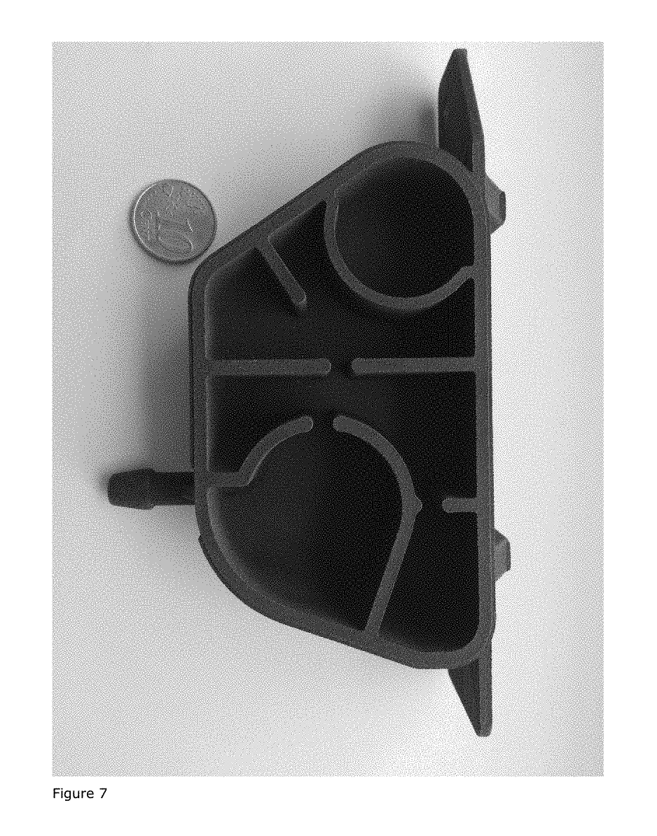

An exemplary photograph of such a half of an automotive fluid tank was taken and is shown in FIG. 7 (the 10 cent coin being shown for size comparison).

Fashion bracelets were produced by SLS on Prodways, Promaker 4000X machine with a build chamber temperature of 183° C., at 65 W laser power (laser hatching spacing of 0.2 mm) using a black powder of example 1. The resulting intricate parts were built to the very edge of the build platform and display easy depowdering, high toughness and high level of rotation freedom.

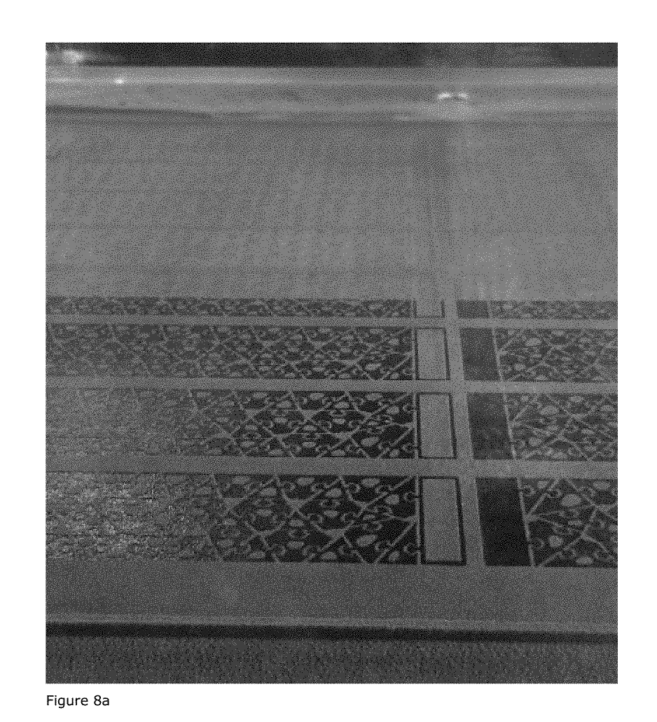

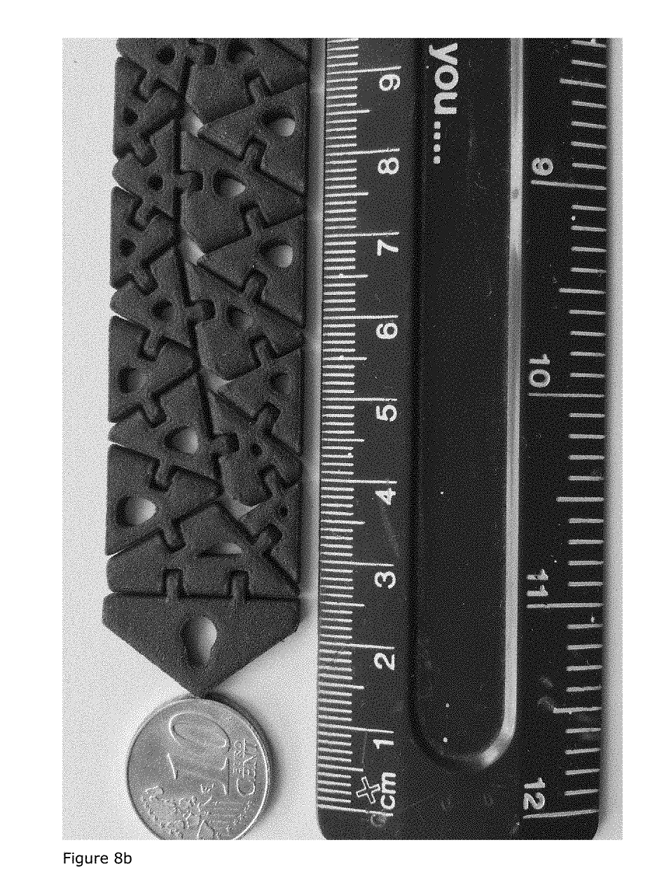

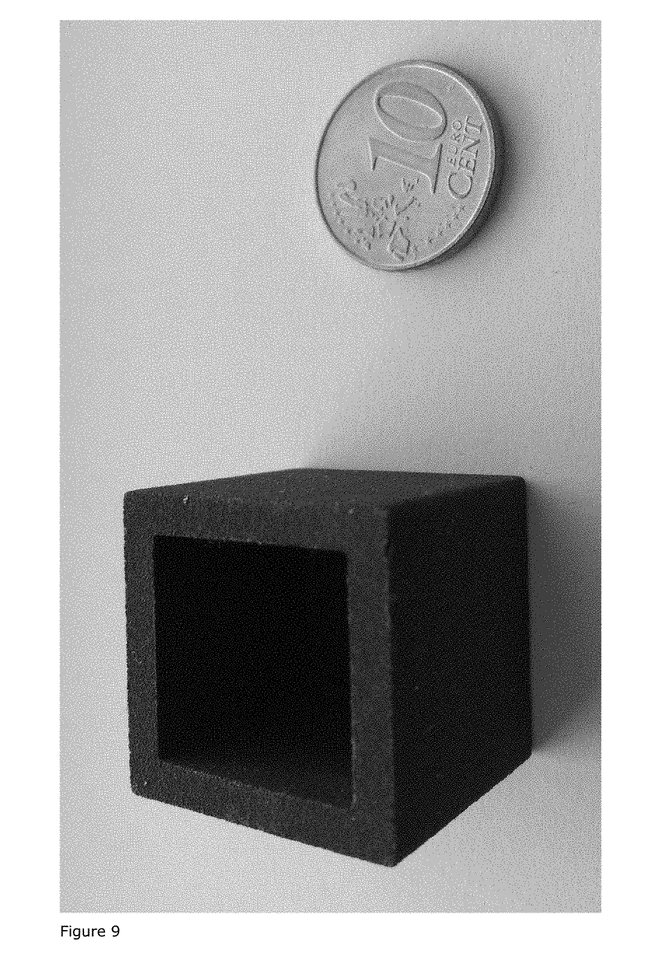

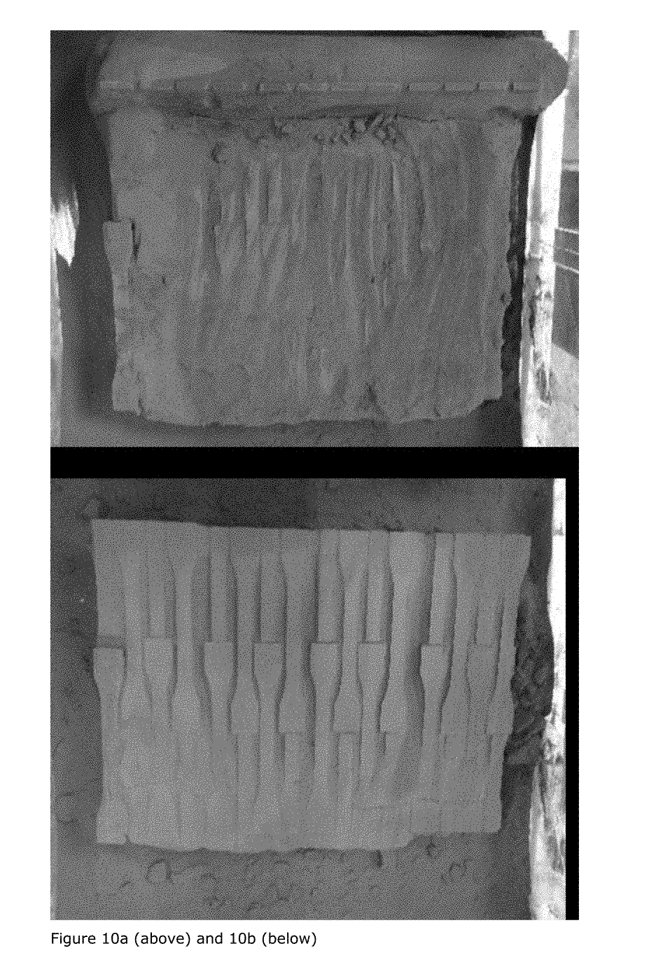

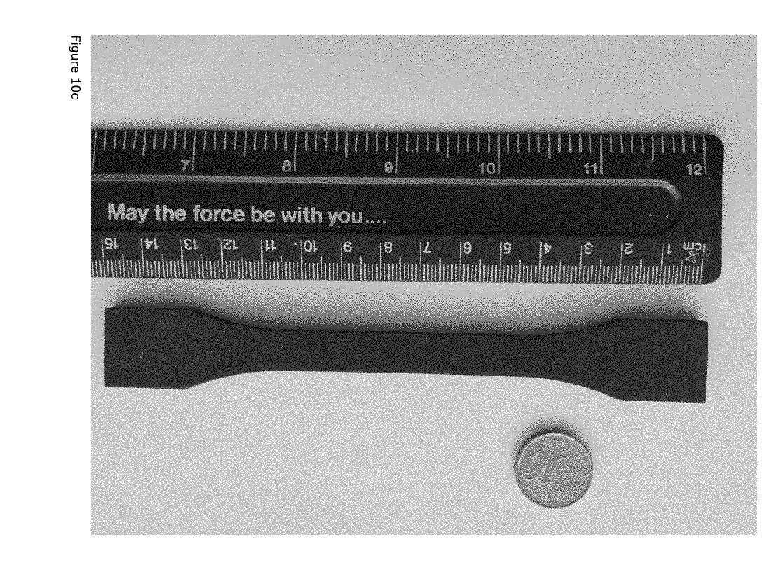

Exemplary photographs of such fashion bracelets were taken during production (FIG. 8a) and after cooling and depowdering (FIG. 8b) (the 10 cent coin being shown for size comparison).

Cubes were prepared from a powder of the invention being free of dust without the application of high pressure air or beadblast.

An exemplary photograph of such a cube was taken and is shown in FIG. 9 (the 10 cent coin being shown for size comparison).

Cakes were prepared from the present Invention's powders and were easy to break up and clean; dogbones could be revealed with a brush.

Exemplary photographs of such cakes were taken and are shown in FIG. 10a (before brushing) and FIG. 10b (after brushing). Additionally, an exemplary photograph of such dogbones was taken and is shown in FIG. 10c.

From the examples it can be seen that the compounded copolyamide powders of the present invention, the process of the present invention and the use of the compounded copolyamide powders or the compounded copolyamide powders prepared with the process of the present invention provide for unexpected and surprising, beneficial technical results.

The various embodiments of the present invention like those outlined above and those listed in the specific embodiments and the claims can be combined with each other in any desired manner.

The scope of the invention shall accordingly include all modifications and variations that may fall within the scope of the various embodiments of the present invention like those outlined above and those listed in the claims. Other embodiments of the invention will be apparent to person skilled in the art from consideration of the specification and practice of the invention disclosed herein.

1. Compounded copolyamide powder characterized in that it comprises or consists of
a) at least one semi-aromatic nylon 6 containing at least one aromatic component and at least one aliphatic component, in particular the nylon copolymer being present in at least 50 wt % in the composition, more particularly in an amount of 80 wt. % to 99.5 wt. %, more particularly 94 wt. % to 99 wt. %;
b) at least one heat stabilizer/antioxidant, in particular a phosphorous antioxidant and/or copper halide, more particular a copper iodide, particularly in an amount of 0.5 wt. % to 6 wt. %;
c) optionally at least one color imparting compound, in particular a pigment such as carbon black, particularly in an amount of 0 wt. % to 5 wt. %, more particularly 0.5 to 4 wt. %;
d) optionally at least one reinforcing additive and/or flow additive, in particular aluminum oxide and/or hydrophobic fumed silica and/or particular glass micro beads, particularly in an amount of 0 wt. % to 45 wt. %, more particularly in an amount of 2.5 wt % to 40 wt %;
e) optionally functional additives and in particular phosphonate-containing flame retardant, particularly in an amount of from 5 to 20 wt.-%;
the percentages being based on the entire compounded copolyamide powder, representing 100 wt.-%.

2. Powder according to claim 1, characterized in that the nylon copolymer is a copolymer of nylon 612, nylon 6I (hexamethylenediamine (HMD) and isophthalic acid) and nylon 6T (HMD and terephthalic acid).

3. Powder according to claim 1, characterized in that the nylon copolymer is a copolymer of nylon 612, containing at least 9 mol % or at least 10 wt % of aromatic comonomer, in particular terephthalic acid and isophthalic acid, aromatic diamine comonomers particularly xylene diamine and/or phenylene diamine, with a non-stoichiometric ratio of difunctional amine to acid end groups of at least 2.5 mol % and in particular having a relative solution viscosity of 1.4 to 2.0 according to IS0307.

4. Powder according to claim 1, characterized in that the nylon copolymer is a copolymer of nylon 6, such as but not restricted to nylon 64, nylon 610 and nylon 66.

5. Powder according to claim 1, characterized in that the melting point of the nylon copolymer is above 185° C. and the processing window, the difference between the onset temperature on melting and the onset temperature of crystallization is higher than 45° C.

6. Powder according to claim 1, characterized in that the powder is black.

7. Powder according to claim 1, characterized in that the heat stabilizer is iodo-bis(triphenylphosphin)copper.

8. Powder according to claim 1, characterized in that the antioxidant is 3,9-Bis(2,4-di-tert-butylphenoxy)-2,4,8,10-tetraoxa-3,9-diphosphaspiro[5.5]undecan.

9. Powder according to claim 1, characterized in that the color imparting compound is carbon black.

10. Powder according to claim 1, characterized in that it has supercooling crystalline polymer structure behavior.

11. Powder according to claim 1, characterized in that they have at least one of the following properties, particularly two of those and more particularly all of those:
a D50 between 45 and 85 microns, in particular 45-55 microns, and a D99 below 150 microns;
a dry 10 mm flow funnel flowability between 16 seconds and 50 seconds;
a bulk density of 0.4-0.6 g/cm3 according to ASTM D1895-96, and
a particle morphology being rounded or cuboid shape enabling the powder to flow through a 10 mm ASTM D 1895-96.

12. Powder according to claim 1, characterized in that is prepared by the following steps:
(i) melt mixing and compounding the copolyamide, additives other than reinforcing additives and optionally colorants and/or pigments, in particular in an extruder;
(ii) cryogenic grinding of the compounded product of step (i) to produce a powder with adequate particle size distribution and particle morphology, characterized in that the particle size distribution is defined with the following boundaries:
D10: 20-35 micron
D50: 45-70 micron
D90: <120 micron
D99: <150 micron
and the particle morphology is rounded or cuboid shape, in particular enabling the powder to flow through a 10 mm ASTM D1895-96 flow funnel;
(iii) post-addition of reinforcing additives to the ground product of step (ii), in particular via dry blending or melt extrusion;
(iv) optionally particle size adjustment of the products of step (ii) and/or (iii), in particular by sieving and/or air flow classification.

13. Powder according to claim 1, characterized in that it comprises or consists of
a) at least one semi-aromatic nylon 6 containing at least one aromatic component and at least one aliphatic component t, in particular the nylon copolymer being present in at least 50 wt % in the composition, more particularly in an amount of 80 wt. % to 99.5 wt. %, more particularly 94 wt. % to 99 wt. %;
b) at least one heat stabilizer/antioxidant, in particular a phosphorous antioxidant and/or copper halide, more particular a copper iodide, particularly in an amount of 0.5 wt. % to 6 wt. %;]
c) optionally at least one color imparting compound, in particular a pigment such as carbon black, particularly in an amount of 0 wt. % to 5 wt. %, more particularly 0.5 to 4 wt. %;
d) optionally at least one reinforcing additive and/or flow additive, in particular aluminum oxide and/or hydrophobic fumed silica and/or particular glass micro beads, particularly in an amount of 0 wt. % to 45 wt. %, more particularly in an amount of 2.5 wt % to 40 wt %;
e) optionally functional additives and in particular phosphonate-containing flame retardant, particularly in an amount of from 5 to 20 wt.-%;
the percentages being based on the entire compounded copolyamide powder, representing 100 wt.-%, in particular for 3D printing and in particular selective laser sintering, high speed sintering (HSS), powder bed fusion, multi jet fusion, additive manufacturing, further characterized in that it is a single-use powder.

14. Powder according to claim 1, characterized in that
the amount of particles having an average diameter below 20 micron is less than 10 vol. %, in particular less than 5 vol. %,
and/or
they have a wider temperature of usability in standard SLS machines than conventional powders, in particular a window of 40° C. to 50° C., more particularly 45° C.,
and/or
parts, in particular soft cakes, prepared with them have improved depowdering properties,
and/or
parts prepared from them are stiffer than parts prepared from PA6 once conditioned in moisture.

15. Process for preparing compounded copolyamide powders, particularly suitable for additive manufacturing processes such as selective laser sintering and high speed sintering, according to claim 1, characterized in that the process comprises or consists of the following steps:
(i) melt mixing and compounding copolyamide, additives, preferably other than reinforcing additives and optionally colorants and/or pigments, in a mixing device, in particular in an extruder;
(ii) cryogenic grinding of the compounded product of step (i) to produce a powder with a particle size distribution defined with the following boundaries:
D10: 20-35 micron
D50: 45-70 micron
D90: <120 micron
D99: <150 micron
and the particle morphology is rounded or cuboid shape, in particular enabling the powder to flow through a 10 mm ASTM D1895-96 flow funnel;
(iii) post-addition of reinforcing additives to the ground product of step (ii), in particular via dry blending or melt extrusion;
(iv) optionally particle size adjustment of the products of step (ii) and/or (iii), in particular by sieving and/or air flow classification.

16. Process according to claim 15, characterized in that the cryogenic milling of step (ii) proceeds with the following characteristics: −100° C. to −191° C. conveyor screw temperature, −40° C. to −52° C. mill chamber temperature; throughput of 10 to 100 kg/h, mill speed: 7000 to 18000 rpm, in particular 10.200 rpm.

17. Parts made from compounded copolyamide powder according to claim 1.

18. The use of the compounded copolyamide powders prepared according to claim 16 in additive manufacturing, selective laser sintering (SLS), high speed sintering (HSS), powder bed fusion, multi jet fusion, for rapid prototyping or rapid manufacturing, for production of high strength articles thereof by any of the mentioned 3-D printing processes, in particular parts for aerospace applications or formula one vehicles.
